(19) United States
(12) Patent Application Publication
(10) Pub. No.: US 2026/0224926 A1
(43) Pub. Date: Aug. 6, 2026

(54) DEPLOYABLE FIRE BARRIER FOR PROTECTING STRUCTURES AND VEGETATION FROM AN APPROACHING FIRE

(71) Applicant: VIRIDIS ARBOR LLC, Verona, NJ (US)

(72) Inventor: Gary E. Abeles, Verona, NJ (US)

(73) Assignee: VIRIDIS ARBOR LLC, Verona, NJ (US)

(21) Appl. No.: 19/447,365

(22) Filed: Jan. 13, 2026

Related U.S. Application Data
(60) Provisional application No. 63/752,100, filed on Jan. 31, 2025.

(51) Int. Cl. A62C 2/24

(52) U.S. Cl. CPC A62C 2/24

(57) ABSTRACT

A system and method of protecting structures and/or vegetation from an approaching fire comprises a barrier sheet formed by adhering a layer of super-absorbent polymer (SAP) onto a fire-resistant sheet. The barrier sheet is interposed between the fire and the vegetation and/or structure, and water is applied to hydrate the SAP. A structure can be protected by pulling the barrier sheet over the structure using attached cords. The barrier sheet can be pre-stowed in a container near a top of the structure and deployed therefrom by gravity, pulling of cords, and/or inflation of spokes included in the barrier sheet. Spokes inflated by water can include hydration holes and/or capillary tubes extending therefrom and/or therebetween and comprising capillary holes. During spoke inflation, the water can exude from the holes to hydrate the SAP. Barrier sheets can be deployed between upright poles and hydrated to form a vertical firebreak.

### RELATED APPLICATIONS

This application claims the benefit of U.S. Provisional Application No. 63/752,100, filed Jan. 31, 2025, which is herein incorporated by reference in its entirety for all purposes.

### FIELD OF THE INVENTION

The invention relates to apparatus and methods for fighting fires, and more particularly, to apparatus and methods for protecting structures and/or vegetation from an approaching fire.

### BACKGROUND OF THE INVENTION

Recent trends in global climate change have resulted in consistently higher temperatures and persistent droughts in many areas, which in turn have increased the risks and the occurrences of major fires in both wilderness and populated areas. Between 1985 and 2017, the western U.S. has seen an eight-fold increase in annual area burned by severe fires, and fifteen of the largest wildfires that have ever been recorded in the United States have occurred within the past ten years. Recently, several wildfires burned for more than a week in populated areas of Southern California, destroying hundreds of acres of wilderness, and thousands of structures, in multiple regions of Los Angeles County.

Existing methods for fighting fires, and for protecting vegetation and structures that are threatened by a fire, include using hoses to apply water derived from fire hydrants or tanker trucks to the threatened area. However, this approach is limited to applying the water either directly to the fire, or directly in front of the fire, because water that is applied more than a few minutes before the fire arrives will likely evaporate, and will have little effect.

Similarly, with reference to FIG. 1A, when vegetation 100 and/or structures 101 are burning, water 102 can be dropped by an aircraft 104 onto the vegetation 100 and/or structures 101 to slow the advance of the fire 110. However, when the water 102 is applied directly to the fire, much of the water 102 evaporates before it can reach the burning vegetation 100 or structures 101, and aid in extinguishing the fire 100. The benefits of applying water 102 are even further reduced if the water 102 is applied to a structure 101 and/or vegetation 100 that is not yet involved in the fire 110, because much of the applied water will drip off the structure 101 and/or vegetation 100 onto the ground, and/or evaporate, before the fire 110 arrives.

Instead, with reference to FIG. 1B, a fire-retardant “chemical” 108 is often applied to vegetation 106 and/or structures 101 that are either burning, or in the path of a fire 110. Typically, the “chemical” 108 is a mixture of water and ammonium phosphate, together with thickening and coloring agents. It rains down onto the vegetation 106 and/or structures 101 in a sticky film, and adheres to trees, plants, roofs, and surface soils until the fire 110 reaches the vegetation 106 or structures 101, or until it is removed by wind or rain.

However, such fire-retardant chemicals 108 are generally harmful to the environment. For example, a 2011 environmental impact study by the U.S. Forest Service concluded that ammonium phosphate based fire-retardant chemicals can adversely affect water quality, especially in small ponds and vernal pools where a lack of flowing water would hinder retardant dilution and lead to excessive nutrient production that causes algal blooms and starves the water of oxygen. The study concluded that adverse impacts could linger in these systems for two years or more. Furthermore, fire-retardant chemicals 108 are generally available in much smaller quantities than water 102.

Accordingly, in most cases these existing methods of protecting structures and vegetation from an approaching fire must be implemented immediately before the arrival of the fire, which will occur well after civilians have been evacuated from the area, and will require application by professional firefighters. Furthermore, such application of preventative measures immediately before the arrival of a fire can be dangerous, even to fire-fighting professionals.

What is needed, therefore, is an apparatus and method for protecting structures and vegetation from an approaching fire that can be deployed well before the arrival of the fire.

### SUMMARY OF THE INVENTION

The present invention is an apparatus and method for protecting structures and vegetation from an approaching fire that can be deployed well before the arrival of the fire.

According to the present invention, a fire-resistant “barrier sheet” is prepared by applying an adhesive layer to a sheet made from a fire-resistant material, such as fire-resistant Tyvek™, after which a layer of a super-absorbent polymer (SAP) is adhered to the fire-resistant sheet. When the SAP is in a dehydrated state, it adds only a modest thickness to the barrier sheet, such that the barrier sheet can be folded, rolled, or otherwise stowed until needed. Once the barrier sheet is deployed, water is applied to the SAP layer, which becomes water saturated. The SAP then functions to retain the water in the desired location for extended periods of time, thereby allowing the barrier sheet to be deployed and hydrated well before the arrival of a fire.

According to a first general aspect of the present invention, when a structure is threatened by a fire, the barrier sheet can be deployed such that it covers some or all of the threatened structure. If the concern is mainly regarding burning embers from a distant fire that are spread by air currents, and might drift downward onto the structure, it may be sufficient to deploy a partial barrier sheet that extends only over the top of the structure, and functions as a fire-resistant “umbrella” protecting the structure. In embodiments, corners of the barrier sheet can be attached to the ground by ropes, cords, or cables. Additional ropes, cords, or cables can be used to further secure the sides of the barrier sheet.

If a structure is in danger of being directly exposed to an approaching fire, or if strong winds would threaten to cause embers to impact a side of the structure, and/or dislodge a partial barrier sheet, despite efforts to anchor it with ropes or cables, then a full barrier sheet can be deployed that completely covers the structure, whereupon the bottom edges of the barrier sheet can be weighted, staked, or otherwise directly fixed to the ground.

Water can be applied to the deployed barrier sheet by firefighters using fire hoses, or by a civilian using either a conventional water supply that is provided to the structure, and/or from a reservoir of water that is maintained near the structure, such as a swimming pool associated with the structure. In the latter case, embodiments include a pumping system configure to pump the water from the reservoir onto the barrier sheet. In some of these embodiments the pumping system further includes a battery backup system that can power the pump, in case electrical service to the structure is interrupted.

In some embodiments, the barrier sheet is drawn over the structure to be protected by cords, for example by attaching ropes to the barrier sheet and extending them over pullies that have been pre-attached to the roof of the structure, and then pulling the barrier sheet over the structure by pulling on the ropes, either manually, or by winches.

In other embodiments, the barrier sheet is pre-stowed in a container on the roof of a structure to be protected, and then deployed from the container when the structure is threatened by a fire. Depending on the shape of the structure, deployment can be entirely by gravity, for example by providing weights attached to the lower edges of the barrier sheet. In other embodiments, the barrier sheet comprises inflatable spokes, and is deployed by inflating the spokes with either air or water. If water is used to inflate the spokes, an anchor tube can be provided about the lower perimeter of the barrier sheet which, when filled with water, will gravitationally hold the edges of the barrier sheet against the ground. Also, in embodiments where the spokes are inflated with water, small hydration holes can be provided in the sides of the spokes, and/or capillary tubes penetrated by small capillary holes can extend from and/or between the spokes, so that the SAP is hydrated by the water as the spokes are inflated.

According to a second general aspect of the present invention, the disclosed barrier sheet can be used to establish a vertical “fire break” that will stop, or at least slow, the advance of a fire. According to this approach, vertical support poles are pre-positioned and spaced apart along the route of the fire break. Barrier sheets as described above are stowed either vertically adjacent to the poles, or horizontally between the bottoms or tops of the poles. When a fire is approaching, the barrier sheets are extended between the poles, and water is applied to the SAP included in the barrier sheets, thereby forming a hydrated vertical barrier that will resist the progress of the fire across the fire break.

Depending on the embodiment, cords can extend between the poles near upper ends thereof, and vertically stowed barrier sheets can be drawn by the cords in the manner of curtains to extend between the poles. In other embodiments, the barrier sheets are stowed horizontally, such that they span between the poles either near the tops thereof or near grade, and are deployed in the manner of window shades to extend between the poles.

A first general aspect of the present invention is a system for protecting a structure and/or vegetation from an approaching fire. The system includes a barrier sheet comprising a sheet of fire-resistant material, a layer of an adhesive applied to the sheet of fire-resistant material, and a layer of a superabsorbent polymer (SAP) adhered to the sheet of fire-resistant material by the layer of adhesive. The system further includes a deployment mechanism configured to deploy the barrier sheet into a deployed configuration wherein the barrier sheet is extended between the approaching fire and the protected structure and/or vegetation.

In embodiments, the deployment mechanism comprises ropes, cords, and/or cables fixed to and extending from the barrier sheet, the ropes, cords, and/or cables being configured to enable the barrier sheet to be pulled into the deployed configuration.

In any of these embodiments, the system can be configured for protecting a structure, and the deployment mechanism can include a plurality of pulleys fixed to the structure and configured to guide and support the ropes, cords, and/or cables as the barrier sheet is pulled into the deployed configuration.

In any of these embodiments, the system can be configured for protecting a structure, and the deployment mechanism can include a container cooperative with the structure, the container being configured to enclose and store the barrier sheet in a stowed configuration before it is deployed into the deployed configuration. In some of these embodiments, the container is fixed to the structure at a container location that is proximate a highest feature of the structure. In some of these embodiments, the deployment mechanism is configured to cause the barrier sheet to be deployed to the deployment configuration at least in part due to gravitational forces.

In any of the above embodiments in which the system is configured for protecting a structure and the deployment mechanism comprises a container cooperative with the structure, the barrier sheet can further include a plurality of inflatable spokes, and the deployment mechanism can be configured to cause the barrier sheet to be deployed to the deployment configuration at least in part due to inflation of the spokes. In some of these embodiments the deployment mechanism is configured to cause the barrier sheet to be deployed at least in part due to inflation of the spokes with water, and the barrier sheet further comprises a plurality of hydration holes provided in the spokes and configured to cause water to exude from the spokes onto the SAP as the spokes are inflated with the water. In any of these embodiments, the deployment mechanism can be configured to cause the barrier sheet to be deployed at least in part due to inflation of the spokes with water, the barrier sheet can further comprises a plurality of capillary tubes extending from and/or between the spokes, and capillary holes can be provided in the capillary tubes, the capillary tubes being thereby configured to cause water to flow from the spokes into the capillary tubes, and to exude from the capillary tubes onto the SAP as the spokes are inflated with the water.

In embodiments, the deployment mechanism comprises a plurality of substantially vertical poles, the deployment mechanism being configured to deploy the barrier sheet by extending the barrier sheet between the poles, thereby interposing the barrier sheet between the approaching fire and the vegetation. In some of these embodiments the deployment mechanism is configured to vertically store the barrier sheet proximate one of the poles in a stowed configuration before it is deployed into the deployed configuration, and the deployment mechanism is further configured to deploy the barrier sheet by extending the barrier sheet horizontally between the poles. In other of these embodiments the deployment mechanism is configured to horizontally store the barrier sheet between the poles in a stowed configuration before it is deployed into the deployed configuration, and the deployment mechanism is further configured to deploy the barrier sheet by extending the barrier sheet vertically between the poles.

In any of the above embodiments, the deployment mechanism can include a pump configured to pump the water from a reservoir onto the barrier sheet. In some of these embodiments, the deployment mechanism further includes a battery backup system that can power the pump when electrical service to the structure is interrupted.

A second general aspect of the present invention is a method of protecting a structure and/or vegetation from an approaching fire. The method includes providing a system for protecting the structure and/or vegetation according to any embodiment of the first general aspect, causing the deployment mechanism to deploy the barrier sheet into the deployed configuration, such that the barrier sheet is extended between the approaching fire and the protected structure and/or vegetation, and applying water to the barrier sheet, thereby hydrating the SAP of the barrier sheet.

In embodiments, causing the deployment mechanism to deploy the barrier sheet into the deployed configuration includes pulling on ropes, cords, and/or cables that are fixed to, and extend from, the barrier sheet, thereby moving the barrier sheet into the deployed configuration.

In any of these embodiments, the method can be a method of protecting a structure, providing the system for protecting the structure and/or vegetation can include enclosing and storing the barrier sheet in a container that is fixed at a container location proximate a highest feature of the structure, and causing the deployment mechanism to deploy the barrier sheet into the deployed configuration can include causing the deployment mechanism to extend the barrier sheet from the container into the deployed configuration. In some of these embodiments, the barrier sheet further comprises a plurality of inflatable spokes, and causing the deployment mechanism to deploy the barrier sheet into the deployed configuration comprises inflating the spokes. In some of these embodiments causing the deployment mechanism to deploy the barrier sheet into the deployed configuration comprises causing the deployment mechanism to inflate the spokes with water, the barrier sheet further comprises hydration holes provided in the spokes, and applying the water to the SAP of the barrier sheet comprises causing water to exude from the spokes onto the SAP as the spokes are inflated with the water. In any of these embodiments, causing the deployment mechanism to deploy the barrier sheet into the deployed configuration can include causing the deployment mechanism to inflate the spokes with water, the barrier sheet can further include a plurality of capillary tubes extending from and/or between the spokes, capillary holes being provided in the capillary tubes, and applying the water to the SAP of the barrier sheet comprises, as the spokes are inflated with the water, can cause water to flow from the spokes into the capillary tubes and to exude from the capillary tubes onto the SAP.

In embodiments, the deployment mechanism comprises a plurality of substantially vertical poles, and causing the deployment mechanism to deploy the barrier sheet into the deployed configuration includes causing the deployment mechanism to extend the barrier sheet between the poles, thereby interposing the barrier sheet between the approaching fire and the vegetation. In some of these embodiments providing the system for protecting the structure and/or vegetation comprises vertically stowing the barrier sheet proximate one of the poles in a stowed configuration, and causing the deployment mechanism to deploy the barrier sheet into the deployed configuration comprises causing the deployment mechanism to extend the barrier sheet horizontally between the poles. In other of these embodiments, providing the system for protecting the structure and/or vegetation comprises horizontally storing the barrier sheet between the poles in a stowed configuration, and causing the deployment mechanism to deploy the barrier sheet into the deployed configuration comprises causing the deployment mechanism to extend the barrier sheet vertically between the poles.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates application of water onto a fire from an aircraft according to the prior art;

FIG. 1B illustrates application of a fire-retardant chemical onto a fire from an aircraft according to the prior art;

FIG. 2 is an exploded view of a barrier sheet in an embodiment of the present invention;

FIG. 3A is a front view of a structure having pullies installed thereupon, a barrier sheet stowed proximate the structure, and cables extending from the barrier sheet over the pullies, according to an embodiment of the present invention;

FIG. 3B is a front view of the structure of FIG. 3A showing a barrier sheet partially deployed such that it extends over the front, top, and back of the structure;

FIG. 3C is a perspective view of the structure of Fig. B, showing the barrier sheet fully deployed, so that it extends over the front, top, back, and sides of the structure;

FIG. 4A is a perspective view of a structure having a container mounted proximate a highest location of the structure, a barrier sheet being contained in a stowed configuration within the container according to an embodiment of the present invention;

FIG. 4B is a perspective view of the embodiment of FIG. 4A, showing a partial barrier sheet deployed from the container by inflation of spokes included in the partial barrier sheet, such that the partial barrier sheet extends over the top of the structure;

FIG. 4C is a top view of the partial barrier sheet of FIG. 4B shown extending horizontally from the container;

FIG. 4D is a perspective view of an embodiment that is similar to FIG. 4B, but wherein a full barrier sheet is deployed that extends to grade, thereby covering the top and all sides of the structure;

FIG. 5A is a perspective view of an embodiment of the present invention that is configured to deploy the barrier sheet in a vertical orientation interposed between an approaching fire and a structure and/or vegetation to be protected, the embodiment being shown in a stowed configuration; and

FIG. 5B is a perspective view of the embodiment of FIG. 5A, shown in a deployed configuration.

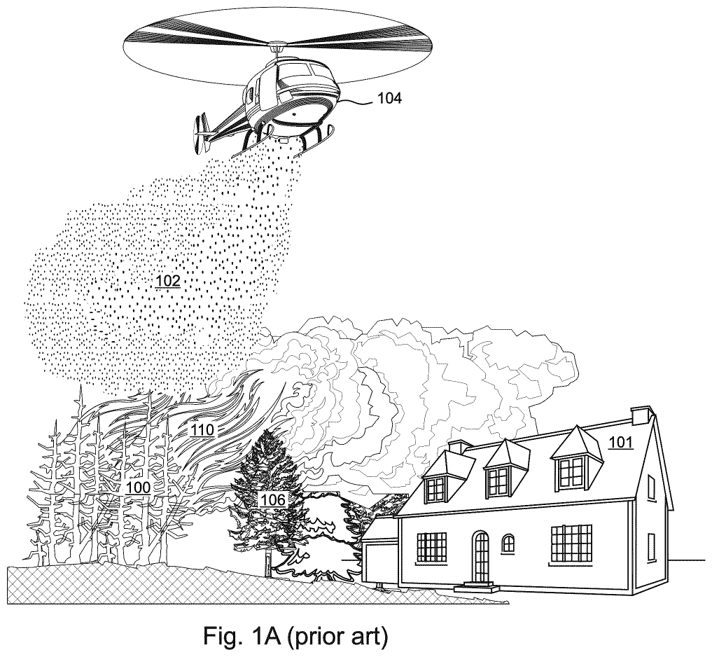

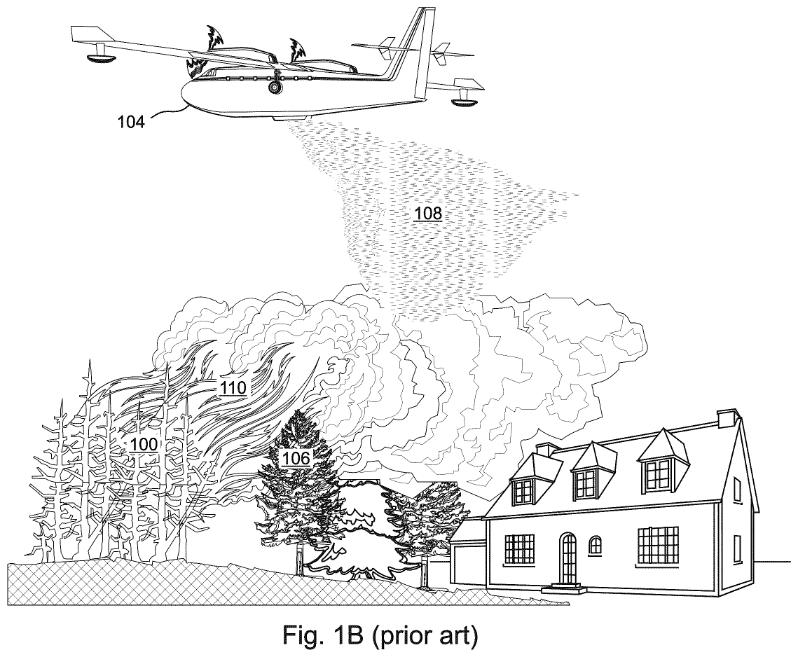

### DETAILED DESCRIPTION

The present invention is an apparatus and method for protecting structures and/or vegetation from an approaching fire that can be deployed well before the arrival of the fire.

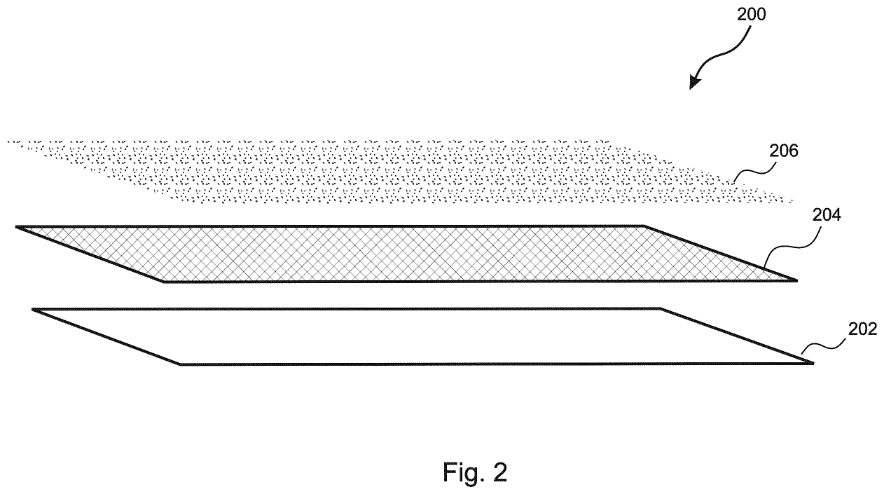

With reference to the exploded view of FIG. 2, according to the present invention a fire-resistant “barrier sheet” 200 is prepared by applying an adhesive layer 204 to a sheet 202 made from a fire-resistant material, such as fire-resistant Tyvek™, after which a layer of a super-absorbent polymer (SAP) 206 is adhered to the fire-resistant sheet 202 by the adhesive layer 204. When the SAP 206 is in a dehydrated state, it adds only a modest thickness to the barrier sheet 200, such that the barrier sheet 200 can be folded, rolled, or otherwise stowed until needed. Once the barrier sheet 200 is deployed, water is applied to the SAP layer 206, which becomes water saturated. The SAP 206 then functions to retain the water in the desired location for long periods of time, thereby allowing the barrier sheet 200 to be deployed and hydrated well before the arrival of a fire.

It will be understood that the term “barrier sheet” is used herein to refer generically to any configuration of one or more barrier sheets as described herein that are configured to function cooperatively as a fire barrier.

Water can be applied to the deployed barrier sheet 200 after its deployment by firefighters using fire hoses, or by a civilian using either a conventional water supply that is provided to the structure, and/or from a reservoir of water that is maintained near the structure, such as a swimming pool associated with the structure. In the latter case, embodiments include a pump system configured to pump the water from the reservoir onto the barrier sheet. In some of these embodiments the pump system further include a battery backup that can power the pump, in case electrical service to the structure is interrupted.

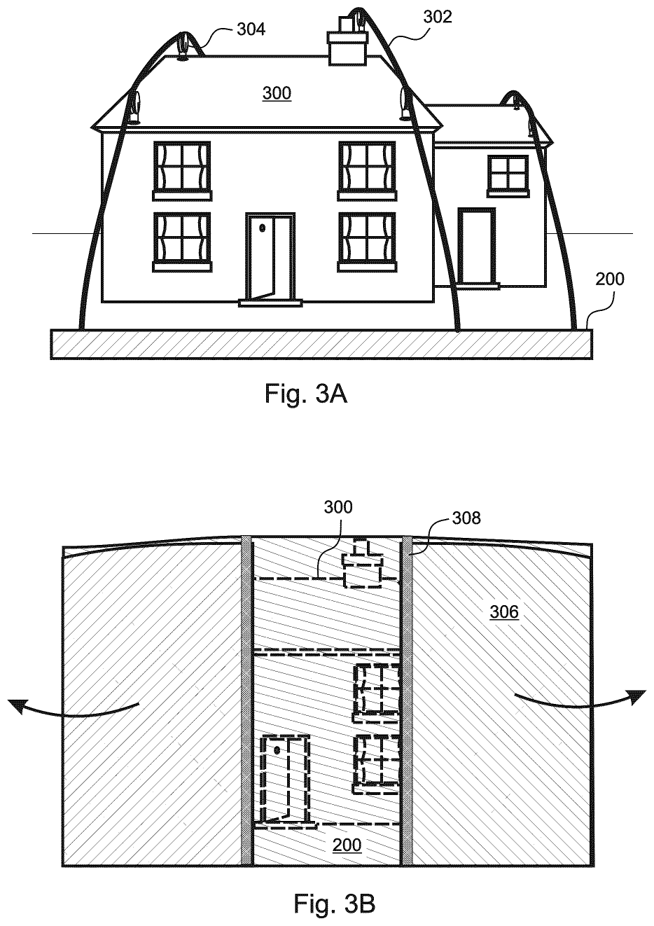

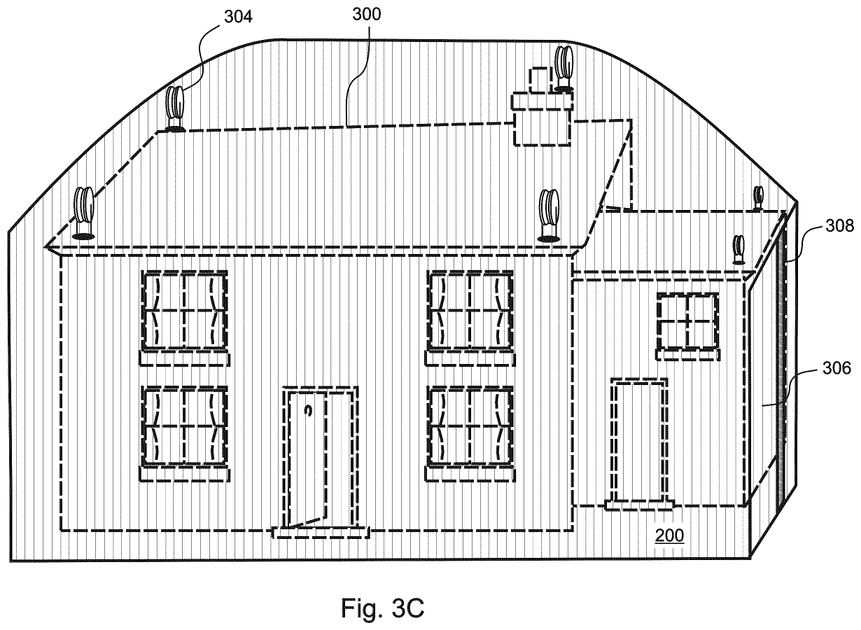

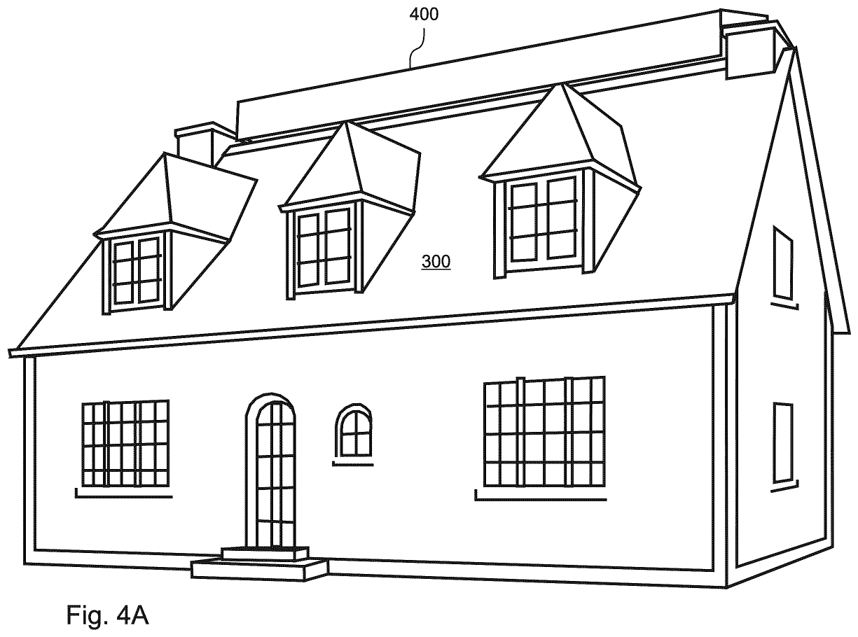

In a first general aspect of the present invention, with reference to FIGS. 3A-3C, when a structure 300 is threatened by a fire 110, the barrier sheet 200 can be drawn over the structure 300 by pulling on ropes, cords, or cables 302 attached to the barrier sheet 200. The ropes, cords, or cables 302 can extend over pullies 304 that have been pre-attached to the roof of the structure 300, as shown in FIG. 3A, such that the barrier sheet 200 can be extended over the structure 300, as shown in FIG. 3B, by pulling on the ropes, cords, or cables 302, either manually, or by winches. In the embodiment of FIG. 3B, the barrier sheet 200 includes side flaps 306 that can be folded outward after the barrier sheet 200 is pulled over the structure 200, and can be joined together, by hook-and-loop 308 or other fastening means, to cover the sides of the structure 300, as well as the top, front, and rear of the structure 300, as shown in FIG. 3C.

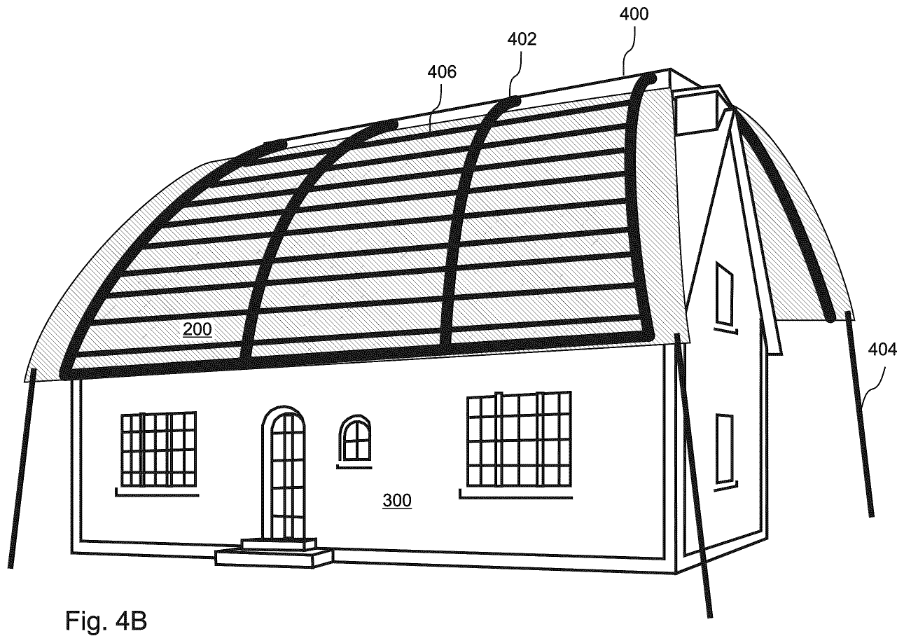

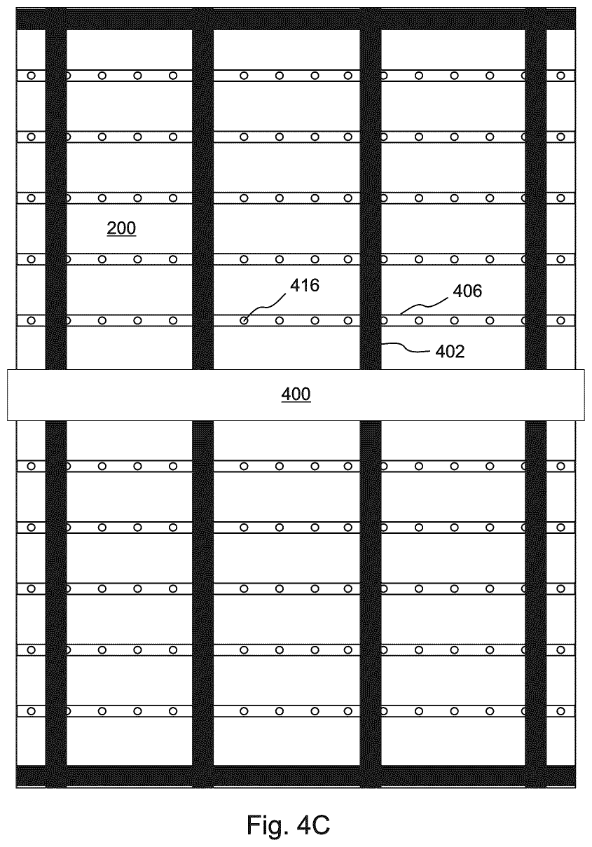

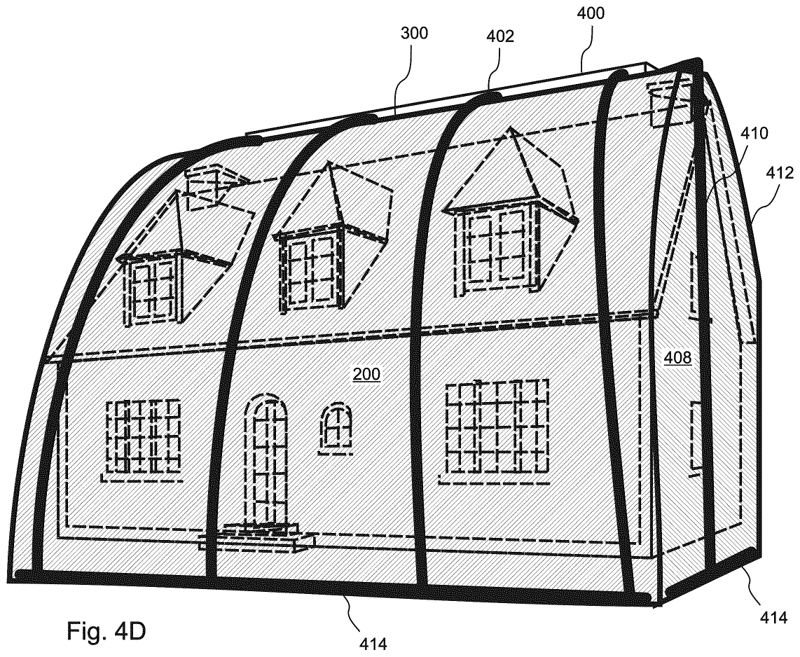

With reference to FIGS. 4A-4D, in other embodiments the barrier sheet 200 is pre-stowed within a container 400 that is positioned on the roof of a structure 300 to be protected, as illustrated in FIG. 4A, and then deployed when the structure 300 is threatened by a fire. Depending on the shape of the structure 300, deployment can be entirely by gravity, for example by providing weights attached to the lower edges of the barrier sheet 200. In other embodiments, with respect to FIGS. 4B-4D , the barrier sheet 200 comprises inflatable spokes 402, and is deployed by inflating the spokes 402 with either air or water.

With reference to FIGS. 4B and 4C, in some embodiments where the spokes 402 are inflated with water, small hydration holes (not shown) can be provided in the sides of the spokes 402, and/or capillary tubes 406 penetrated by small capillary holes 416 can extend laterally from and/or between the spokes 406, so that the SAP 206 is hydrated by the water as the spokes 402 are inflated. FIG. 4B is a perspective view of a structure 300 with the barrier sheet 200 deployed, while FIG. 4C is a view from above showing the barrier sheet 200 of FIG. 4B extending horizontally outward from the container 400.

If the structure 300 primarily requires protection from burning embers from a distant fire that are spread by air currents, and might drift downward onto the structure 300 from above, then it may be sufficient to deploy a partial barrier sheet 200, as illustrated in FIG. 4B, which extends only over the top of the structure 300, and functions as a fire-resistant “umbrella” protecting the structure 300. In the embodiment of FIG. 4B, corners of the partial barrier sheet are attached to the ground by ropes, cords, or cables 404. Additional ropes, cords, or cables 404 are used in similar embodiments to further secure the sides of the barrier sheet to the ground, as needed.

With reference to FIG. 4D, if a structure 300 is in danger of being directly exposed to an approaching fire, or if strong winds would threaten to cause embers to impact a side of the structure 300, and/or to dislodge a partial barrier sheet 200, despite efforts to anchor it with ropes and/or cables 404, then a full barrier sheet 200 can be deployed that completely covers the structure 300, whereupon the bottom perimeter of the barrier sheet 200 can be weighted, staked, or otherwise directly fixed to the ground.

In the embodiment of FIG. 4D, side panels 408 of the full barrier sheet 200 are separately deployed by inflated side spokes 410, and are attached to the front and rear panels by hook-and-loop 412, and/or by other means as known in the art. In the illustrated embodiment, the spokes 402, 410 are inflated by water, and the embodiment further includes anchoring tubes 414 provided about the lower perimeter of the barrier sheet 200, 408 which, when filled with the water, will gravitationally hold the edges of the barrier sheet 200, 408 against the ground.

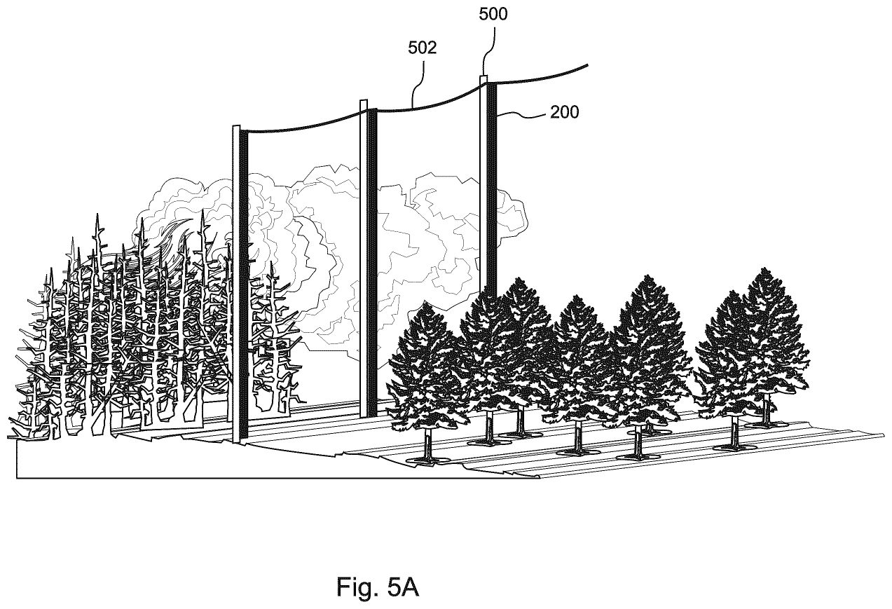

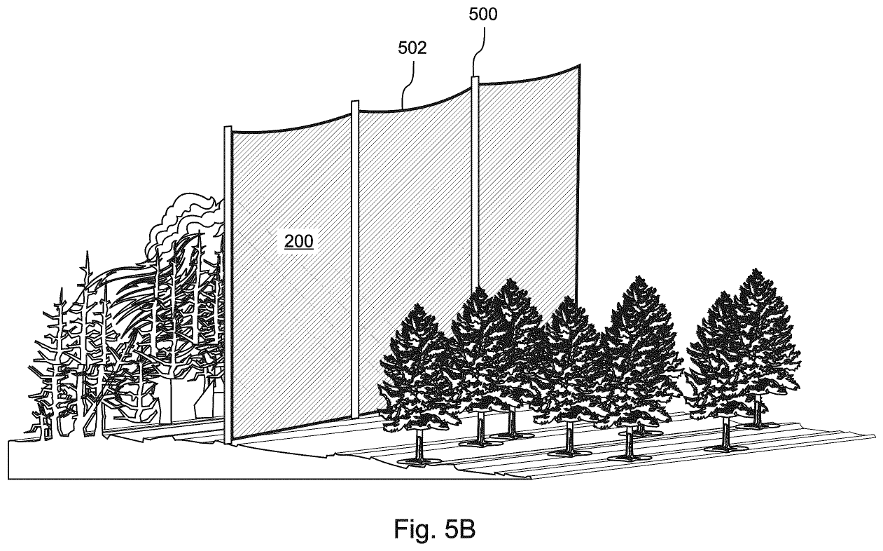

With reference to FIGS. 5A and 5B, in a second general aspect of the present invention the disclosed barrier sheet 200 can be used to establish a vertical “fire break” that will stop, or at least slow, the advance of a fire. According to this approach, vertical support poles 500 are pre-positioned and spaced apart along the route of the fire break. Barrier sheets 200 as described above are stowed either vertically adjacent to the poles 500, as shown in FIG. 5A, or horizontally between the bottoms or tops of the poles 500. When a fire is approaching, the barrier sheets 200 are extended between the poles 500, and water is applied to the SAP 206 included in the barrier sheets 200, thereby forming a hydrated barrier that will resist the progress of the fire across the fire break.

In the embodiment of FIGS. 5A and 5B, cords or cables 502 extend between the poles 500 near upper ends thereof, and vertically stowed barrier sheets 200 are drawn by the cords 502 in the manner of curtains to extend between the poles 500. In other embodiments, the barrier sheets 200 are stowed horizontally, such that they extend between the poles 500, either near the tops thereof or near grade, and are deployed vertically in the manner of window shades.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed.

Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

1: A system for protecting a structure and/or vegetation from an approaching fire, the system comprising:
a barrier sheet comprising:
a sheet of fire-resistant material;
a layer of an adhesive applied to the sheet of fire-resistant material; and
a layer of a superabsorbent polymer (SAP) adhered to the sheet of fire-resistant material by the layer of adhesive; and
a deployment mechanism configured to deploy the barrier sheet into a deployed configuration wherein the barrier sheet is extended between the approaching fire and the protected structure and/or vegetation.

2: The system of claim 1, wherein the deployment mechanism comprises ropes, cords, and/or cables fixed to and extending from the barrier sheet, the ropes, cords, and/or cables being configured to enable the barrier sheet to be pulled into the deployed configuration.

3: The system of claim 2, wherein the system is configured for protecting a structure, and wherein the deployment mechanism comprises a plurality of pulleys fixed to the structure and configured to guide and support the ropes, cords, and/or cables as the barrier sheet is pulled into the deployed configuration.

4: The system of claim 1, wherein the system is configured for protecting a structure, and wherein the deployment mechanism comprises a container cooperative with the structure, the container being configured to enclose and store the barrier sheet in a stowed configuration before it is deployed into the deployed configuration.

5: The system of claim 4, wherein the container is fixed to the structure at a container location that is proximate a highest feature of the structure.

6: The system of claim 5, wherein the deployment mechanism is configured to cause the barrier sheet to be deployed to the deployment configuration at least in part due to gravitational forces.

7: The system of claim 4, wherein:
the barrier sheet further comprises a plurality of inflatable spokes; and
the deployment mechanism is configured to cause the barrier sheet to be deployed to the deployment configuration at least in part due to inflation of the spokes.

8: The system of claim 7, wherein:
the deployment mechanism is configured to cause the barrier sheet to be deployed at least in part due to inflation of the spokes with water; and
the barrier sheet further comprises a plurality of hydration holes provided in the spokes and configured to cause some of the water to exude from the hydration holes onto the SAP as the spokes are inflated with the water.

9: The system of claim 7, wherein:
the deployment mechanism is configured to cause the barrier sheet to be deployed at least in part due to inflation of the spokes with water;
the barrier sheet further comprises a plurality of capillary tubes extending from and/or between the spokes; and
capillary holes are provided in the capillary tubes, the capillary tubes being thereby configured to cause some of the water to flow from the spokes into the capillary tubes, and to exude from the capillary holes onto the SAP as the spokes are inflated with the water.

10: The system of claim 1, wherein the deployment mechanism comprises a plurality of substantially vertical poles, the deployment mechanism being configured to deploy the barrier sheet by extending the barrier sheet between the poles, thereby interposing the barrier sheet between the approaching fire and the vegetation and/or structure.

11: The system of claim 10, wherein:
the deployment mechanism is configured to vertically store the barrier sheet proximate one of the poles in a stowed configuration before it is deployed into the deployed configuration; and
the deployment mechanism is further configured to deploy the barrier sheet by extending the barrier sheet horizontally between the poles.

12: The system of claim 10, wherein:
the deployment mechanism is configured to horizontally store the barrier sheet between the poles in a stowed configuration before it is deployed into the deployed configuration; and
the deployment mechanism is further configured to deploy the barrier sheet by extending the barrier sheet vertically between the poles.

13: The system of claim 1, wherein the deployment mechanism comprises a pump configured to pump the water from a reservoir onto the barrier sheet, and a battery backup system that can power the pump when electrical service to the structure is interrupted.

14: A method of protecting a structure and/or vegetation from an approaching fire, the method comprising:
providing a system for protecting the structure and/or vegetation according to claim 1;
causing the deployment mechanism to deploy the barrier sheet into the deployed configuration, such that the barrier sheet is extended between the approaching fire and the protected structure and/or vegetation; and
applying water to the barrier sheet, thereby hydrating the SAP of the barrier sheet.

15: The method of claim 14, wherein:
the method is a method of protecting a structure;
providing the system for protecting the structure and/or vegetation comprises enclosing and storing the barrier sheet in a container that is fixed at a container location proximate a highest feature of the structure; and
causing the deployment mechanism to deploy the barrier sheet into the deployed configuration comprises causing the deployment mechanism to extend the barrier sheet from the container into the deployed configuration.

16: The method of claim 15, wherein:
the barrier sheet further comprises a plurality of inflatable spokes; and
causing the deployment mechanism to deploy the barrier sheet into the deployed configuration comprises inflating the spokes.

17: The method of claim 16, wherein:
causing the deployment mechanism to deploy the barrier sheet into the deployed configuration comprises causing the deployment mechanism to inflate the spokes with water;
the barrier sheet further comprises hydration holes provided in the spokes; and
applying the water to the SAP of the barrier sheet comprises causing some of the water to exude from the hydration holes onto the SAP as the spokes are inflated with the water.

18: The method of claim 16, wherein:
causing the deployment mechanism to deploy the barrier sheet into the deployed configuration comprises causing the deployment mechanism to inflate the spokes with water;
the barrier sheet further comprises a plurality of capillary tubes extending from and/or between the spokes, capillary holes being provided in the capillary tubes; and
applying the water to the SAP of the barrier sheet comprises, as the spokes are inflated with the water, causing some of the water to flow from the spokes into the capillary tubes and to exude from the capillary holes onto the SAP.

19: The method of claim 14, wherein:
the deployment mechanism comprises a plurality of substantially vertical poles; and
causing the deployment mechanism to deploy the barrier sheet into the deployed configuration comprises causing the deployment mechanism to extend the barrier sheet between the poles, thereby interposing the barrier sheet between the approaching fire and the vegetation.

20: The method of claim 19, wherein:
either:
providing the system for protecting the structure and/or vegetation comprises vertically stowing the barrier sheet proximate one of the poles in a stowed configuration; and
causing the deployment mechanism to deploy the barrier sheet into the deployed configuration comprises causing the deployment mechanism to extend the barrier sheet horizontally between the poles;
or:
providing the system for protecting the structure and/or vegetation comprises horizontally storing the barrier sheet between the poles in a stowed configuration; and
causing the deployment mechanism to deploy the barrier sheet into the deployed configuration comprises causing the deployment mechanism to extend the barrier sheet vertically between the poles.
